(19) United States
(12) Patent Application Publication
(10) Pub. No.: US 2025/0092835 A1
(43) Pub. Date: Mar. 20, 2025

(54) WIRELESS THROTTLE CONTROLLER SYSTEM AND A METHOD THEREOF

(71) Applicant: Innotech Products LLC, Bainbridge Island, WA (US)

(72) Inventor: Tyson M. Colby, Bainbridge Island, WA (US)

(21) Appl. No.: 18/471,227

(22) Filed: Sep. 20, 2023

(51) Int. Cl. F02D 11/10

(52) U.S. Cl. CPC F02D 11/105

(57) ABSTRACT

A wireless throttle controller system is disclosed. The wireless throttle controller system comprises a plurality of sensors installed within a vehicle, configured to generate signals based at least on a movement of the vehicle and a movement of a shift arm attached to the vehicle. Further, at least one controller communicatively coupled to the plurality of sensors, is configured to determine a motor shift position of the vehicle based on the generated signals. Further, at least one computing device communicatively coupled to the controller, facilitates a user to send one or more commands to the at least one controller. The at least one controller, based on the one or more commands and the determined motor shift position of the vehicle, controls a throttle response of the vehicle to precisely control speed of the vehicle. The at least one controller is installed underneath cowling of a motor of the vehicle.

### CROSS REFERENCE TO RELATED APPLICATION

The present application claims the benefit of U.S. Provisional Application No. 63/376,565 filed Sep. 21, 2022 and is incorporated by reference herein.

### FIELD OF THE INVENTION

The invention generally relates to watercraft devices and more specifically, relates to a wireless throttle controller system and a method thereof for outboard motors of the watercraft devices.

### BACKGROUND OF THE INVENTION

“Trolling” is a fishing technique that includes dragging or pulling a bait or lure through open water at a specific speed which is referred to as a trolling speed. The motion, presentation, and overall success of the lure to hook a fish depends upon the trolling speed of a boat or a streamer at which the lure or bait is dragged through the water. The effective trolling speed depends on the weather, type of water, and the variety of fish. Such effective trolling speeds are relatively slow and require a wide range of control and finesse of a throttle position at low revolutions per minute (RPMs). Although it is generally acknowledged that smaller, dedicated trolling motors may maintain slower trolling speeds more precisely and offer greater control than large outboard main engines, however, accurate and repeatable control of the trolling motor's throttle position is still necessary.

To precisely adjust the RPMs of the trolling motors and the speed of boats through water is a challenge due to the typical mechanical linkage found on all types of trolling motors. Additionally, consistently achieving precise throttle positioning for trolling motors presents a notable challenge. Certain previous systems lack full integration within the motor cowling. These systems raise various concerns, both in terms of user experience and safety, as they necessitate routing wires either outside the motor cowling or through the boat's transom. Also, some existing systems demand wire cutting or the installation of sensors in the binnacle to detect the neutral shift position. Additionally, certain current systems may require extra power sources and may not interface with the pre-existing power supplies within the cowling.

Therefore, there is a need for an improved throttle controller system that offers a high degree of resolution and repeatability to complement a motor's existing stock mechanical control.

### SUMMARY OF THE INVENTION

According to embodiments illustrated herein, an improved, and easy to use wireless throttle controller system is disclosed. The wireless throttle controller system includes a plurality of sensors installed over a vehicle. The plurality of sensors is configured to generate one or more signals based at least on a movement of the vehicle and a movement of a shift arm attached to the vehicle. Further, the wireless throttle controller system comprises at least one controller communicatively coupled to the plurality of sensors. The at least one controller is mounted underneath the cowling of a motor of the vehicle. The at least one controller is configured to determine a motor shift position of the vehicle based at least on the generated one or more signals. Further, at least one computing device is communicatively coupled to the controller. The at least one computing device facilitates a user to send one or more commands to the at least one controller. Thereafter, the at least one controller, based at least on the one or more commands and the determined motor shift position of the vehicle, controls a throttle response of the vehicle to precisely control speed of the vehicle.

In one embodiment, the plurality of sensors corresponds to one or more inertial measurement unit (IMU) sensors, and wherein at least one of the IMU sensors is a reference sensor and other one of the IMU sensors is a shift position sensor. The reference sensor and the shift position sensor correspond to an accelerometer, a gyroscope, and a magnetometer.

In some embodiments, the reference sensor is configured to be mounted over the vehicle to determine real time movement of the vehicle, and wherein the shift position sensor is coupled to a gear arrangement of the vehicle and to determine movement of the shift arm.

In some embodiments, the at least one controller is coupled to an actuator that facilitates controlling of throttle response of the vehicle based at least on the one or more commands and the determined motor shift position of the vehicle. The actuator is a common radio control (RC) servo motor or a stack linear actuator.

In some embodiments, the position of the at least one controller is re-oriented with recalibration of the wireless throttle controller system.

In some embodiments, the motor shift position of the vehicle includes neutral, forward, and reverse position. In some embodiments, the at least one controller drives the actuator to control the throttle response of the vehicle. In some embodiments, the at least one controller drives the actuator to control the throttle response of the vehicle, upon determining the motor shift position of the vehicle in either forward or reverse position.

In some embodiments, the at least one computing device includes a mobile phone, a remote controller, or a web browser.

In some embodiments, the at least one controller acts as a Wi-Fi-access point (AP) or a station to facilitate wireless communication with the at least one computing device operated by the user.

In some embodiments, the at least one controller implements a RESTful API or a web socket API to communicate with the user, wherein the at least one controller serves as a front-end web application to the user to configure the at least one controller.

In some embodiments, the one or more commands comprises at least one of increasing the speed of the vehicle, decreasing the speed of the vehicle, setting the vehicle on cruise control, resetting the throttle, or setting throttle 126 position to idle.

According to embodiments illustrated herein, a method for the wireless throttle controller system is disclosed. The method includes the steps of: generating, via a plurality of sensors, one or more signals based at least on a movement of the vehicle and a movement of a shift arm attached to the vehicle; determining, via at least one controller communicatively coupled to the one or more sensors, a motor shift position of the vehicle based at least on the generated one or more signals; sending, via at least one computing device communicatively coupled to the at least one controller, one or more commands to the at least one controller.

In some embodiments, the method includes driving, via the at least one controller, an actuator to control a throttle response of the vehicle based at least on the one or more commands and the determined motor shift position of the vehicle.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate and not to limit the scope in any manner, wherein similar designations denote similar elements, and in which:

FIG. 1A illustrates a block diagram of a wireless throttle controller system, in accordance with at least one embodiment;

FIG. 1B illustrates an actuator coupled to a motor throttle linkage of a vehicle, in accordance with at least one embodiment;

FIG. 1C illustrates a user interface of the wireless throttle controller system, in accordance with at least one embodiment;

FIG. 2A illustrates various components of the wireless throttle controller system, in accordance with at least one embodiment;

FIG. 2B illustrates various positions of a shift arm of a motor, in accordance with at least one embodiment;

FIG. 2C illustrates various positions of a shift arm of a different motor, in accordance with at least one embodiment;

FIG. 3 illustrates the at least one controller acting as a Wi-Fi access point (AP), in accordance with at least one embodiment;

FIG. 4 illustrates the at least one controller acting as a station, in accordance with at least one embodiment;

FIG. 5 illustrates the wireless throttle controller system acting as a Proportional-Integral-Derivative (PID) controller, in accordance with at least one embodiment; and

FIG. 6 is a flowchart illustrating a method for the wireless throttle controller system. in accordance with at least one embodiment.

### DETAILED DESCRIPTION OF THE PREFERRED EMBODIMENT

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Various embodiments of the present disclosure disclose a wireless throttle controller system intended to deliver precise control of the throttle position of outboard trolling motors. The wireless throttle controller system may be easily adapted to existing outboard motors. The wireless throttle controller system gives a user an enhanced ability to sense the motor revolutions per minute (RPM) and to control the motor's throttle position over its existing stock methods. The wireless throttle controller system provides the user with a fine grain control and repeatability to motor's throttle position which ultimately translates to fine grain control and repeatable boat speed through water. Therefore, the wireless throttle controller system is flexible and may integrate with other systems or devices that use common web technologies.

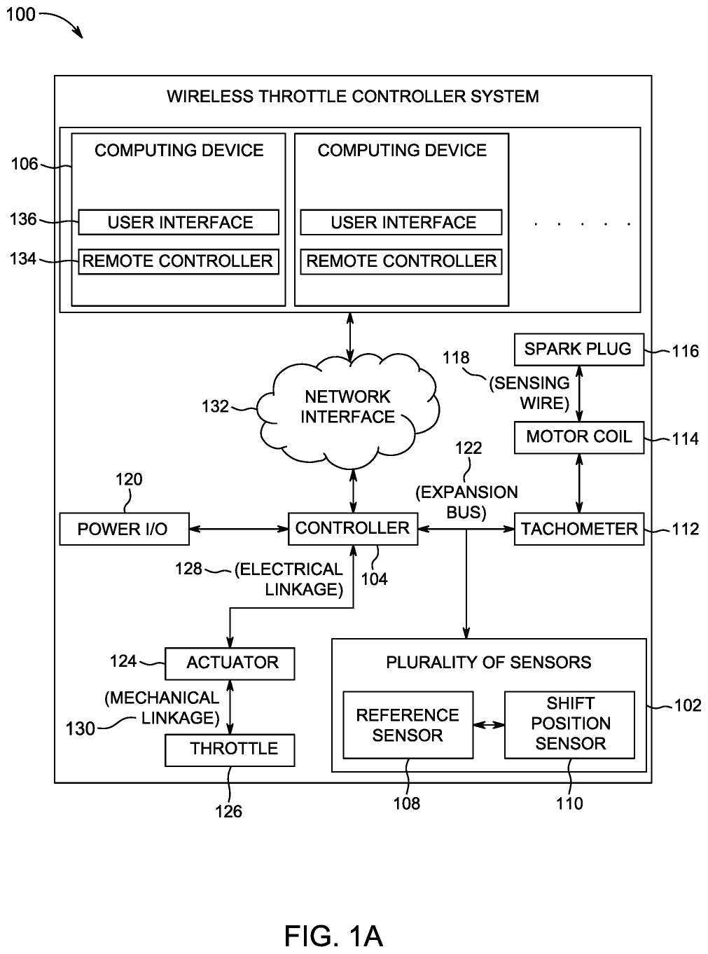

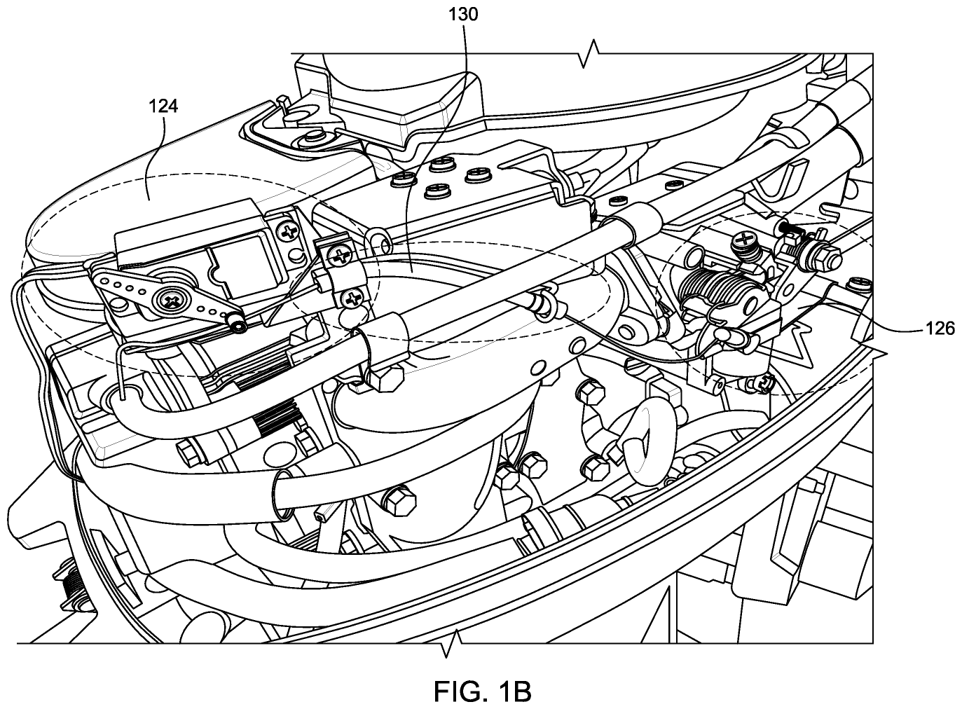

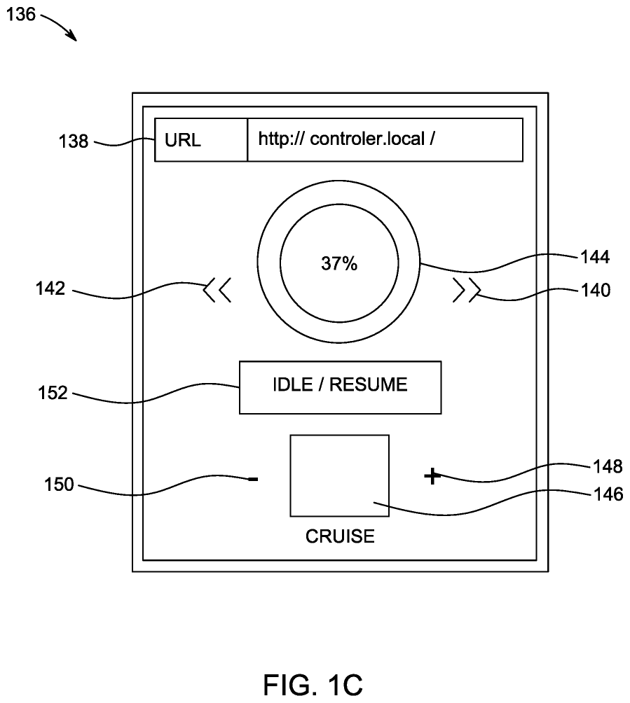

FIG. 1A illustrates a block diagram of a wireless throttle controller system 100, in accordance with at least one embodiment. The wireless throttle controller system 100 may comprise a plurality of sensors 102, at least one controller 104, and at least one computing device 106. The plurality of sensors 102 may comprise a reference sensor 108 and a shift position sensor 110. Further, the wireless throttle controller system 100 includes at least one tachometer 112, a motor coil 114, at least one spark plug 116, a sensing wire 118, a power input (I/O) 120 and at least one expansion bus 122.

The plurality of sensors 102 may be installed within a vehicle (not shown). In some embodiment, the plurality of sensors 102 may correspond to one or more inertial measurement unit (IMU) sensors. The plurality of sensors 102 may be configured to generate one or more signals based at least on a movement of the vehicle and a movement of a shift arm (not shown) attached to the vehicle. It may be noted that the vehicle may be referred to a boat or a watercraft, without departing from the scope of the disclosure. Hereinafter, the vehicle and the boat may be used interchangeably. Further, the one or more IMU sensors may comprise the reference sensor 108 and the shift position sensor 110. In some embodiments, the reference sensor 108 may be configured to be installed directly over the vehicle. For example, the reference sensor 108 is installed to a fixed location on a motor body (not shown) of the vehicle.

Further, the shift position sensor 110 may be configured to be installed directly to a gear arrangement (not shown) of a motor (not shown) of the vehicle. In some embodiments, the reference sensor 108 and the shift position sensor 110 may include an accelerometer, a gyroscope, and a magnetometer. In some embodiments, the plurality of sensors 102 may be coupled to the at least one expansion bus 122.

The at least one tachometer 112 may be coupled to the at least one expansion bus 122. The at least one tachometer 112 may be configured to measure revolutions per minutes (RPM) of the motor of the vehicle. In some embodiments, the at least one tachometer 112 may by coupled to the motor coil 114 of the vehicle. The at least one tachometer 112 measures RPM of the motor coil 114 by measuring a time interval between incoming pulses that are generated due to the revolution of motor coil 114 inside the motor. In some example embodiments, as the speed of the motor coil 114 increases, the frequency of the incoming pulses increases and thereby measurement of the RPM increasing accordingly.

As discussed above, the wireless throttle controller system 100 may comprise the at least one spark plug 116. The at least one spark plug 116 may be electrically connected to the motor coil 114 via the sensing wire 118. It may be noted that the at least one spark plug 116 may be an electrical device that ignites an air fuel mixture for combustion to release thermal energy that facilitates generation of mechanical energy, and thereby rotating the motor of the vehicle. In some embodiments, the sensing wire 118 may include a capacitive pickup wire or an inductive loop. Further, the at least one tachometer 112 may observe frequency at which the at least one spark plug 116 fires by means of the sensing wire 118. In some embodiments, the at least one tachometer 112, via the sensing wire 118, may be configured to detect actual RPM of the motor for the vehicle. It will be apparent to a skilled person that the detection of actual RPM of the motor may be performed using known devices without departing from the scope of the disclosure.

Further, the at least one controller 104 may be communicatively coupled to the plurality of sensors 102. The at least one controller 104 may be installed underneath a cowling (not shown) of motor of the vehicle. The at least one controller 104 may be powered by the power I/O 120. It may be noted that the power I/O 120 may include at least 12 volts (V) direct current (DC) power bus of the motor. In some embodiments, the at least one controller 104 may be configured to determine a motor shift position of the vehicle based at least on the generated one or more signals. The motor shift position of the vehicle may include neutral, forward, and reverse direction. In some example embodiments, the at least one controller 104 may include a raspberry pi, an esp32 watch, an esp32 dev board with screen, a signal K or any other controller, known in the art. In some other example embodiments, the at least one controller 104 may integrate with Internet of Things (IoT) ecosystem.

Further, the at least one controller 104 may further comprise a processor (not shown) and a memory (not shown). In some embodiments, the processor may include suitable logic, circuitry, and/or interfaces that are operable to execute one or more instructions stored in the memory to perform predetermined operations. In one embodiment, the processor may be configured to decode and execute any instructions received from one or more other electronic devices or server(s). The processor may be configured to execute one or more computer-readable program instructions, such as program instructions to carry out any of the functions described in this description. Further, the processor may be implemented using one or more processor technologies known in the art. Examples of the processor include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

Further, the memory may store a set of instructions and data. Further, the memory may include the one or more instructions that are executable by the processor to perform specific operations. It is apparent to a person with ordinary skill in the art that the one or more instructions stored in the memory enable the hardware of the system to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

Further, the at least one controller 104 may be communicatively coupled to the plurality of sensors 102 and the tachometer 112, via the at least one expansion bus 122. In some embodiments, the at least one expansion bus 122 may be a set of electrical connections or pathways that allows additional hardware components such as, the plurality of sensors 102 and the at least one tachometer 112 to be connected and communicated with the at least one controller 104. The at least one expansion bus 122 provides a standardized way for the additional hardware components to interact and exchange data. It may be noted that the at least one expansion bus 122 may have a varied length and of any type. Further, the type of the at least one expansion bus 122 may be a Serial Peripheral Interface (SPI), Inter-integrated Circuit (I2C), RS232, RS485, CAN Bus, or other serial communication protocol.

Further, the wireless throttle controller system 100 may comprise an actuator 124 and a throttle 126. The at least one controller 104 may be coupled to the actuator 124, via an electrical linkage 128. In some embodiments, the actuator 124 may include a common radio control (RC) servo motor or a can stack linear actuator. Further, the actuator 124 may be coupled to the throttle 126 of the motor, via a mechanical linkage 130. It may be noted that various motor kits may be used to mount the actuator 124 to linkage of different motors. In some embodiments, the mechanical linkage 130 may include a cable or a push rod. The at least one controller 104 may be configured to operate the actuator 124 to alter throttle response of the vehicle. The throttle response may include the change in the throttle 126 position. In some embodiments, the at least one controller 104 may terminate the activation of the actuator 124 unless the motor shift position of the boat is shifted into forward or reverse direction. The operation of the at least one controller 104 is described in greater detail in conjunction with FIGS. 1B-5.

Referring to FIG. 1A, the at least one computing device 106 may be communicatively coupled to the at least one controller 104, via a network interface 132. The network interface 132 may facilitate a communication link between the at least one computing device 106 and the at least one controller 104. It may be noted that the network interface 132 may further facilitate a communication link among the other components of the system 100. Further, the network interface 132 may be a wireless network and/or a wired network. The network interface 132 may be implemented using one or more communication techniques. The one or more communication techniques may be Radio waves, Wi-Fi, Bluetooth, ZigBee, Z-wave and other communication techniques, known in the art.

In one embodiment, the at least one computing device 106 may allow a user to send one or more commands i.e. input commands to the at least one controller 104 to alter the speed of the vehicle. The one or more input commands may include, but is not limited to, increasing the speed of the vehicle, decreasing the speed of the vehicle, setting the vehicle on cruise control, resetting the throttle, setting throttle position to idle, or executing a “script” of speed commands with varying time intervals in between the speed commands. For example, the time interval includes a cycle between 2.5 miles per hour (mph) and 3.0 mph, every 90 seconds. In some embodiments, the at least one computing device 106 may be a remote controller 134. The remote controller 134 may further include a smartphone, a tablet, a laptop, a personal computer (PC), a smart watch or a purpose built Wi-Fi enabled remote controller. In one embodiment, the user may use the smartphone or the tablet as a client/host device. In another embodiment, a dedicated Android or IOS application may be developed to interact with the at least one controller 104. Further, the dedicated application may be used to discover, configure, and command the at least one controller 104.

In another embodiment, the user may use the smartphone or the tablet to connect to the at least one controller's 106 web server by opening browser application and navigating to the at least one controller 104's web address. In another embodiment, the user may configure the at least one controller 104 via the at least one controller's Representational State Transfer (RESTful) application programming interface (API) or Web Socket API. It may be noted that the user may use one computing device 106 or various computing devices at the same time, without departing from the scope of the disclosure.

Further, the at least one computing device 106 may include a user interface (UI) 136 for interacting with the wireless throttle controller system 100 to send the one or more commands. The UI 136 may receive the one or more commands from the user. Further, the UI 136 may provide an output to the user based on the received one or more commands. Further, the UI 136 may perform both the aforementioned actions. The UI 136 may either be a Command Line Interface (CLI), Graphical User interface (GUI), or a voice interface. The UI 136 is further described in conjunction with FIG. 1C.

FIG. 1C illustrates the UI 136 of the wireless throttle controller system 100, in accordance with at least one embodiment. FIG. 1C is described in conjunction with FIGS. 1A and 1B.

In one embodiment, the UI 136 may include a web server UI. Further, the user, via the UI 136, may connect to the controller's web server by opening browser application and navigating to at least one controller's web address 138. In some embodiments, the at least one controller's web address 138 may be uniform resource locator (URL), website, etc. In one embodiment, the user may increase the speed of the vehicle via a button 140. In another embodiment, the user may decrease the speed of the vehicle, via a button 142. The UI 136 may include a screen 144 to display the status of the speed of the vehicle, or the RPM or the throttle 126 position. Further, the users may also have the option to use a cruise control 146 to automatically control the speed of the vehicle. It may be noted that the user may increase the speed in the cruise control 146, via a button 148. It may also be noted that the user may decrease the speed in the cruise control 146, via a button 150. In one embodiment, the user may command the throttle 126 position, via a button 152. Further, the user may be notified about the motor shift position on the screen 144. It may be noted that the motor shift position may include neutral, forward and reverse position.

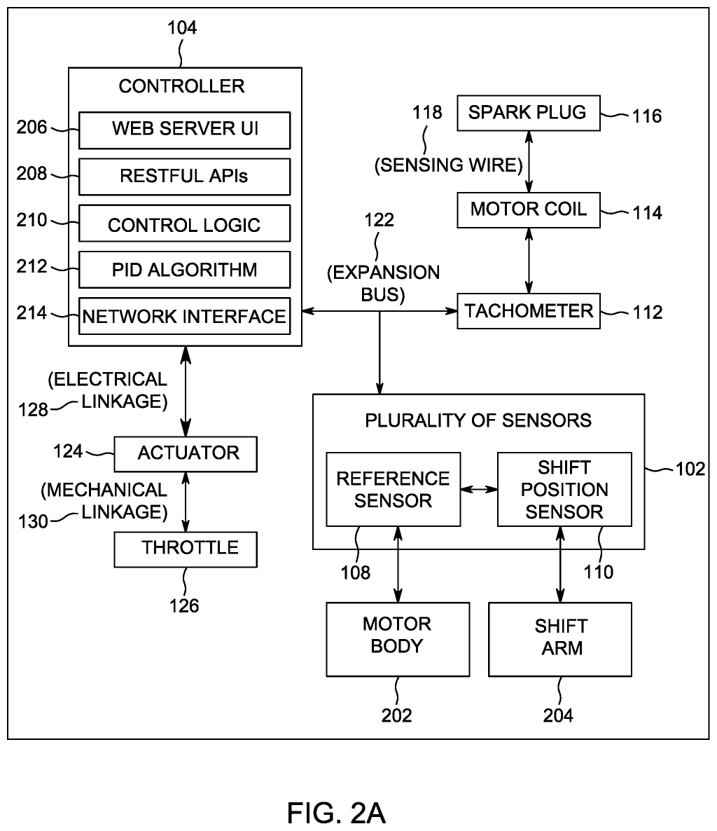

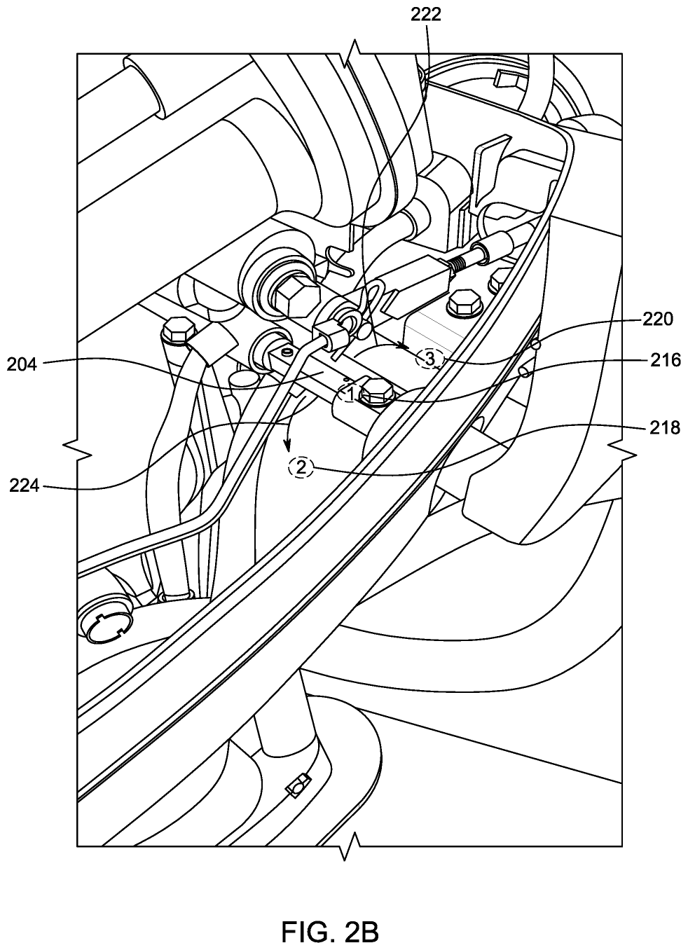

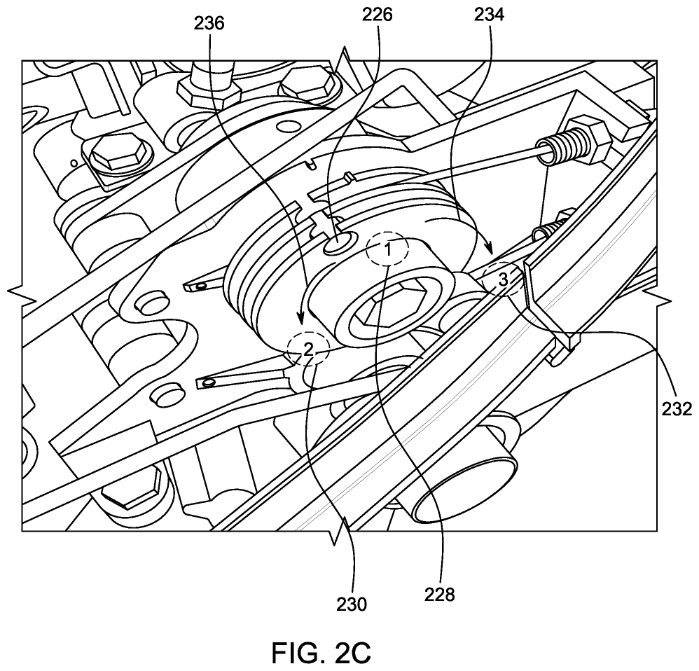

FIG. 2A illustrates various components of the wireless throttle controller system 100, in accordance with at least one embodiment. FIG. 2B illustrates various positions of a shift arm 204 of a motor, in accordance with at least one embodiment. FIGS. 2A-2B are described in conjunction with FIGS. 1A-1C.

The wireless throttle controller system 100 may include the plurality of sensors 102 and the at least one controller 104. The plurality of sensors 102 may further include the reference sensor 108 mounted over a motor body 202 and the shift position sensor 110 mounted to a shift arm 204. The reference sensor 108 may be configured to sense real time movement of the vehicle. In one embodiment, the reference sensor 108 may be rigidly mounted over the vehicle or over the motor body 202. In another embodiment, the reference sensor 108 may be rigidly mounted to any static feature on the motor or the vehicle. It may be noted that the static feature includes any movable mechanical part of the motor or the vehicle. Further, the shift position sensor 110 may be configured to sense movement of the shift arm 204 when switching between different gear shift positions. In one embodiment, the shift position sensor 110 may be mounted to the shift arm 204 of the motor of the vehicle. In another embodiment, the shift position sensor 110 may be mounted to a shift mechanism (not shown) of the motor.

In one embodiment, the shift arm 204 of the motor may be configured to change the motor shift position of the vehicle. The shift arm 204 of the motor may be in one of three positions, as shown in FIG. 2B. The three positions may include a first position 216, a second position 218 and a third position 220. It may be noted that in the first position 216, the shift arm 204 may be in a “neutral” position. In the second position 218, the shift arm 204 may be in the “reverse” position. In the third position 220, the shift arm 204 may be in the “forward” position. For example, when the motor is shifted into “forward” position, the shift arm 204 rotates in clockwise direction i.e. approximately 30 degrees to third position 220, as indicated by an arrow 222. In another example, when the motor may be shifted into “reverse” position, the shift arm 204 may rotate anti clockwise approximately −30° to second position 218, as indicated by an arrow 224.

Referring to FIG. 2C, the shift position sensor 110 may be coupled to a shift arm 226 of a different motor in one of three positions. The three positions may include a first position 228, a second position 230 and a third position 232. It may be noted that in the first position 228, the shift arm 204 is in the “neutral” position. In the second position 230, the shift arm 204 is in the “reverse” position. Further, in the third position 232, the shift arm 204 is in the “forward” position. In one example, when the motor may be shifted into “forward” position, the shift arm 204 may rotate clockwise approximately 40 degrees) (° to third position 232, as indicated by an arrow 234. In another example, when the motor may be shifted into “reverse” position, the shift arm 204 may rotate anti clockwise approximately −40° to second position 230, as indicated by an arrow 236.

It may be noted that the determination of the orientation of the shift position sensor 110 may remain the same when the shift arm 204 is shifted into the three positions. In some embodiments, as long as the shift position sensor 110 may be mounted to any non-static feature such as the shift arm 204 and mount the reference sensor 108 over the vehicle, it may be determined whether the orientation of the shift position sensor 110 has changed position relative to the orientation of the reference sensor 108. Further, the actual shift pattern of the motor in reverse, neutral, or forward position may be determined based on the determination of the relative orientation of the shift position sensor 110.

In one embodiment, the at least one controller 104 may be configured to detect the motor shift position by comparing the values of the plurality of sensors 102. Further, the at least one controller 104 may monitor orientation of the plurality of sensors 102 in real time to determine if the shift position sensor 110 has changed orientation relative to the reference sensor 108. As a result, the at least one controller 104 may determine whether the motor is in forward or reverse or neutral.

Further, the at least one controller 104 may be configured to determine how much to increase or decrease the throttle 126 position to match the detected actual RPM of the motor to the desired RPM. Thereafter, the at least one controller 104, based on the detected motor shift position and the change in the RPM of the motor based on actual RPM and desired RPM, may operate the actuator 124 to change the throttle 126 position. It may be noted that the at least one controller 104 may be interlocked and not allowed to change the throttle 126 response unless the motor shift position is shifted into forward or reverse. Thus, based on the detected motor shift position and the change in the RPM of the motor based on actual RPM and desired RPM, the at least one controller 104 may control the trolling speed of the vehicle.

Further, the at least one controller 104 may include a web server user interface (UI) 206, a RESTful API 208, a control logic 210, a Proportional-Integral-Derivative (PID) algorithm 212 and a network interface 214. In one embodiment, the at least one controller 104 may serve the web server UI 206. It may be noted that the web server UI 206 may include a simple front end web application that gives the user a user-friendly UI. Further, the web server UI 206 may be hosted on the at least one controller 104 Itself. Further, the web server UI 206 may be accessible through a web browser. The web server UI 206 may allow the user to interact with and configure the at least one controller 104. The web server UI 206 may allow the user to monitor and adjust parameters in real-time. It may be noted that the web server UI 206 may display the plurality of sensors 102 data and options to control the trolling speed of the vehicle.

In some embodiments, the at least one controller 104 may implement the RESTful API 208. The RESTful API 208 may expose the necessary functionality to the user to configure the at least one controller 104. In another embodiment, the at least one controller 104 may implement a web socket API. Further, The RESTful API 208 may serve as the backbone for communication and integration of the wireless throttle controller system 100 with other systems or devices. The RESTful API 208 may enable external hardware or applications to interact with the at least one controller 104 by sending HTTP requests and receiving responses in a standardized manner.

In another embodiment, the at least one controller 104 may include the control logic 210. The control logic 210 may include one or more algorithms to process the data of the plurality of sensor 102 and the user input to determine the optimal control actions. In one embodiment, the control logic 210 may include simple on/off switches, complex algorithms or remotely updatable firmware to maintain desired set points.

In another embodiment, the at least one controller 104 may further include the PID algorithm 212. The PID algorithm 212 may calculate an error value as the difference between a desired set point and a measured process variable. The desired set point may a desired speed or desired RPM. The measured process variable may be the measured speed or measured RPM. Further, the PID algorithm 212 may minimize the error value to ensure stable and accurate control over the speed or RPM. In one embodiment, the throttle 126 position may be maintained by closing the loop on various forms of feedback, including, but not limited to, the motors RPM, GPS speed, and speed through water.

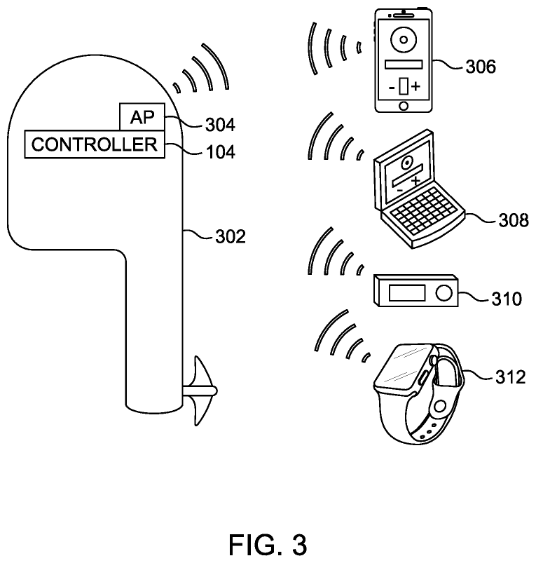

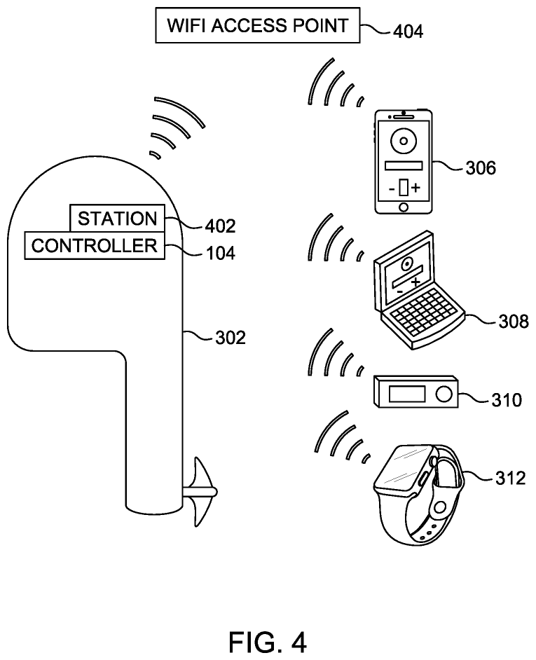

In some embodiments, the at least one controller 104 may include the network interface 214. The network interface 214 may enable communication with the at least one controller 104 and the at least one computing device 106. The network interface 214 may include wireless protocols such as Wi-Fi or Bluetooth protocols or ZigBee or other radio based transport or protocols. The network interface 214 may integrate with Internet of Things (IoT) ecosystem for enhanced automation and data analysis. It may be noted that the enhanced automation and data analysis is user controlled. In one embodiment, the at least one controller 104 may act as a Wi-Fi Access Point (AP) or as a Station depending on the user's needs and install arrangement which is described in FIGS. 3 and 4.

FIG. 3 illustrates the at least one controller 104 acting as a Wi-Fi access point (AP), in accordance with at least one embodiment. FIG. 3 is described in conjunction with FIGS. 1A-2C.

In one embodiment, the at least one controller 104 integrated inside a motor 302 may act as a Wi-Fi AP 304. It may be noted that the at least one controller 104 may wake up in the Wi-Fi AP 304 mode with a default service set identifier (SSID)/pre-shared key (PSK). Further, the at least one controller 104 may act as the Wi-Fi AP 304 or hotspot. In some embodiments, a temporary Bluetooth connection may be used for initial configuration. In another embodiment, the at least one controller 104 may allow the user to change the AP SSID/PSK.

In one embodiment, various computing devices 106 may be directly connected to the at least one controller's Wi-Fi network to interact with the at least one controller 104. The various computing devices 106 may include a smartphone 306, a PC 308, a purpose built Wi-Fi enabled remote 310 or a smart watch 312 or other. The various computing devices 106 may be configured as a remote controller 134 to interact with the at least one controller 104. In this case, a self-hosted controller user interface (UI) may be hosted on the at least one controller 104 itself.

In one embodiment, the various computing devices 106 may leverage the self-hosted UI on the at least one controller 104 itself. Further, the various computing devices 106 with a web browser may connect to proper URL. The proper URL may include either the IP address or the hostname of the at least one controller 104. In one example, the IP address ishttp://192.168.5.1. In another example, the hostname ishttp://controller_hostname.local. Further, the at least one controller 104 may include an embedded web server. The embedded web server may present the self-hosted UI in the web browser. Thereafter, the user may interact with the web application using various computing devices 106 to control the wireless throttle controller system 100.

In one embodiment, one key benefit of the at least one controller 104 acting as a Wi-Fi AP 304 may include localized control, and communication. As a result, the at least one controller may enable various computing devices 106 to establish a dedicated network connection onboard the vehicle. Further, the at least one controller 104 acting as Wi-Fi AP 304 may ensure real-time, low-latency communication to enhance safety and responsiveness in critical situations. For example, during high-speed, the user may use the smartphone 306 to change throttle response of the vehicle instantly while another user present in the vehicle may simultaneously monitor the change in speed of the vehicle on the smart watch 312.

FIG. 4 illustrates the at least one controller 104 acting as a Wi-Fi station device 402, in accordance with at least one embodiment. FIG. 4 is described in conjunction with FIG. 3.

In one embodiment, the at least one controller 104 coupled inside the motor 302 may act as the Wi-Fi station device 402. Further, an external Wi-Fi access point (AP) 404 may be present. It may be noted that the Wi-Fi AP 404 may include a Wi-Fi router or a Wi-Fi hotspot. The at least one controller 104 may be configured to join the network of the external Wi-Fi AP 404. Further, the various computing devices 106 may be configured to also join the same network of the external Wi-Fi AP 404. On the same external Wi-Fi AP 404, the at least one controller 104 and the various computing devices 106 may communicate easily. In one embodiment, the at least one controller 104 may act as the Wi-Fi station device 402 when a large number of computing devices 106 needs to connect to the same network. It may be noted that the user may supply the SSID/PSK for the at least one controller 104 to the user to bind to the external Wi-Fi AP 404.

In one embodiment, the Wi-Fi AP 404 may be configured to take the burden of routing packets. Further, the Wi-Fi AP 404 may be configured to maintain connections freeing up the at least one controller 104 and the large number of computing devices to merely communicate with each other without burdening the at least one controller 104 to act as the overall network Wi-Fi AP 404. Further, the various computing devices 106 may include a smartphone 306, a PC 308, a purpose built Wi-Fi enabled remote 310 or a smart watch 312. The various computing devices 106 may be configured as the remote controller 134 to interact with the at least one controller 104.

In one embodiment, one key benefit of the at least one controller 104 acting as the Wi-Fi station device 402 may include external network connectivity. The at least one controller 104 acting as the Wi-Fi station device 402 may allow the vehicle to connect to external networks to provide access to valuable resources and remote management of the wireless throttle controller system 100. The at least one controller 104 acting as the Wi-Fi station device 402 may enhance the vehicle's versatility to tap into internet-based services, receive updates, and facilitate remote monitoring and diagnostics of the wireless throttle controller system 100. For example, the user may remotely access the at least one controller 104 via the internet to diagnose any maintenance issues or optimize throttle settings, even when the vehicle may be situated at some distance from the user.

It may be noted that fundamental operation of the at least one controller 104 may remain same irrespective of the at least one controller 104 acting as a Wi-Fi access point 304 or the Wi-Fi station device 402.

Further, the at least one controller 104 may host the Wi-Fi network directly, or may connect to an existing Wi-Fi network. It may be noted that once the at least one controller 104 and the various computing devices 106 are connected to a common network, the various computing devices 106 may communicate with the at least one controller 104. Further, the users may access a self-hosted controller user interface (UI) hosted on the at least one controller 104 itself. Further, an external application may be developed to leverage the at least one controller 104 API. It may be noted that in the at least one controller 104 API, both HTTP restful API and a streaming web socket API may exist.

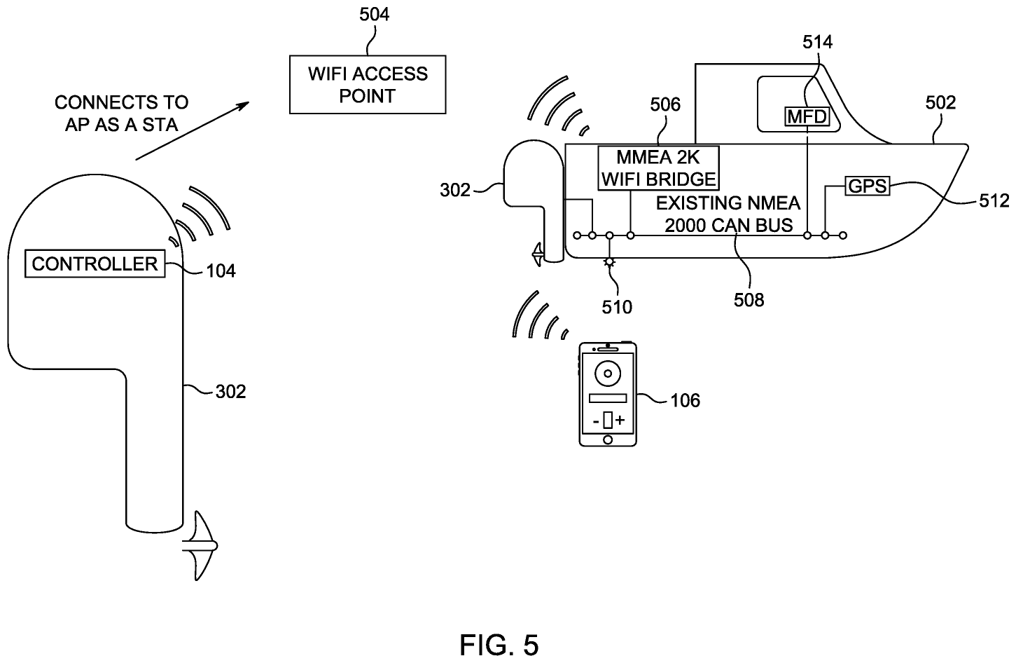

FIG. 5 illustrates the wireless throttle controller system 100 acting as a Proportional-Integral-Derivative (PID) controller, in accordance with at least one embodiment. FIG. 5 is described in conjunction with FIGS. 1A-4.

In some embodiments, the PID controller is a feedback control system to regulate process and maintain desired system set points. The PID controller may provide accurate and stable control of the wireless throttle controller system 100. The wireless throttle controller system 100 acting as the PID controller may deliver precise and adaptable control over the throttle response of the vehicle, and minimize deviations from the system set points to stabilize the wireless throttle controller system 100. In one embodiment, the wireless throttle controller system 100 acting as the PID controller may maintain the throttle response of the vehicle by closing loop on various forms of feedback, including, but not limited to GPS Speed, speed through water measured at the surface of the water, or speed through water measured at the depth of bait/lure presentation and the RPM of the motor of the vehicle, as discussed below.

In an embodiment, the wireless throttle controller system 100 may be configured to act as the PID controller. It may be noted that the PID controller includes a closed loop PID controller. A “system set point” may be set by the user. The system set point may include the desired speed or the desired motor running RPM. The user may set the system set point either through the at least one computing device 106 or by way of an HTTP/web socket request.

Further, the at least one controller 104 may implement a PID loop (not shown). The at least one controller 104 may measure the value of either the actual speed or RPM. Further, the at least one controller 104 may compare the value to the system set point. The difference in the values based on the comparison may be an error. Further, the error may be passed through the PID loop filter to calculate an appropriate output value. The calculated output value may directly change the position of the actuator 124. Further, the change in the position of the actuator 124 may increase or decrease the throttle 126 position accordingly.

In one embodiment, the wireless throttle controller system 100 inside the motor 302 may be coupled to a vehicle 502, for example, a boat. It may be noted that the vehicle 502 may be a boat or a ship. The user may establish communication with the at least controller 106 in an external Wi-Fi network 504, via the at least one computing device 106. The external Wi-Fi network 504 may be an external Wi-Fi access point (AP). Further, a Wi-Fi bridge 506 may be present on the vehicle 502. It may be noted that the Wi-Fi bridge 506 may be a NMEA2000 Wi-Fi bridge. Further, the Wi-Fi bridge 506 may be configured to directly connect to a bus backbone 508 present on the vehicle 502. It may be noted that the bus backbone 508 may be a NMEA2000 CAN bus backbone. It will be apparent to one skilled in the art that The NMEA2000 CAN bus backbone is a standardized (IEC 61162-3) plug and play communications standard used for connecting marine sensors and displays units within ships and boats.

Further, the Wi-Fi bridge 506 may expose one or more data available on the bus backbone 508 to the external Wi-Fi network. One or more data may include speed through water, via a water speed sensor 510 or (global positioning system) GPS speed, via a GPS 512. In one embodiment, the water speed sensor 510 may be located at a depth below the surface of the water. It may be noted that the water speed sensor 510 may not necessarily be located near the surface of the vehicle 502, such as transom mount or through hill mount, however, may otherwise be located remotely at depth below the water surface.

Further, the one or more data may be shared with the at least one controller 104 using standard web technologies like TCP and UDP protocols. As a result, the at least one controller 104 may read the actual speed of the vehicle 502. Thereafter, the at least one controller 104 may then use the actual speed as a form of feedback in the PID loop. It may be noted that the actual speed may be shared via a Wi-Fi gateway. The Wi-Fi gateway may be a the NMEA2000 Wi-Fi gateway.

In one embodiment, the at least one controller 104 may use the desired speed received from the user and the actual speed of the vehicle to regulate the actuation of the throttle 126. It may be noted that the desired speed may be a system set point set by the user, via the at least one computing device 106. Further, the throttle 126 may then automatically increase or decrease to make the actual speed match the desired speed. In one embodiment, the increase or decrease in actual speed may further leverage the speed through water. In an example embodiment, the PID controller discussed above may be similar to cruise control in the vehicle 502. In one embodiment, the one or more data may be managed and displayed on a multifunctional display (MFD) 514 present of the vehicle 502.

In another embodiment, the PID controller discussed above may further be applied for closing the loop on RPM of the motor 302. The user may set the desired RPM, via the at least one computing device 106. The at least one tachometer 112 may be configured to measure the actual RMP. Thereafter, the PID algorithm may determine how much to increase or decrease the throttle 126 position so that the actual RPM matches the desired RPM.

It will be apparent to one skilled in the art that the above-mentioned embodiments of the present invention may be executed by the at least one controller 104 of the wireless throttle controller system 100 using the plurality of sensors 102, without departing from the scope of the disclosure.

In the disclosed embodiments, the at least one controller 104 may be installed or mounted underneath the cowling of the motor 302 in such a way to not interfere with normal operation of the motor 302. Further, the wireless throttle controller system 100 may allow the position of the at least one controller 104 to be moved or re-oriented with recalibration of the wireless throttle controller system 100. Further, the at least one controller 104 may be programmed with hard limits to limit speed of the actuator 124 to limit the increase and decrease of the trolling speed. It may be noted that the speed may mean how fast the actuator 124 may move to drive the throttle 126. Further, the speed may include a maximum sweep speed.

In another embodiment, the motor shift position may be detected using mechanical or non-mechanical switches, including, but not limited to, a lever actuated switch, magnetic hall effect sensors, reed switches, or micro switches. In one embodiment, the mechanical or non-mechanical switches may be rigged in a way that the switch turns on when the shift arm 204 is in different positions. In another embodiment, the wireless throttle controller system 100 may include a dedicated remote controller 134. The remote controller 134 may be mounted anywhere in the vehicle. In one embodiment, the hardware remote controller 134 may be connected to wired power while still communicating with the user in a wireless manner. In another embodiment, the dedicated hardware remote controller may be battery powered.

In some embodiments, the wireless throttle controller system 100 may ensure uninterrupted control of the throttle response, even in cases when the user may disconnect from the at least one controller 104. In the disclosed embodiments, the user may become disconnected from the at least one controller 104 and thus, lose the ability to command the throttle 126 position. As a result, active throttle 126 position may be commanded over a web socket (not shown). Further, the user may continuously stream the desired throttle 126 position at some fixed interval to the at least one controller 104. The at least one controller 104 may then echo the position back to the user upon every transmit as a response.

Further, the at least one controller 104 may assume a safety response by automatically returning the throttle 126 position to idle when a timeout may lapse between two commands given by the user to update the throttle 126 position, or the at least one controller 104 may sense that the socket connection is closed. Alternatively, another reasonable technique may be employed to give the network interface(s) 132, 214 “confidence” that the network interface(s) 132, 214 has an active user connection.

It will be apparent to one skilled in the art that the above-mentioned components of the wireless throttle controller system 100 have been provided only for illustration purposes. In another embodiment, the wireless throttle controller system 100 may include other components without departing from the scope of the disclosure.

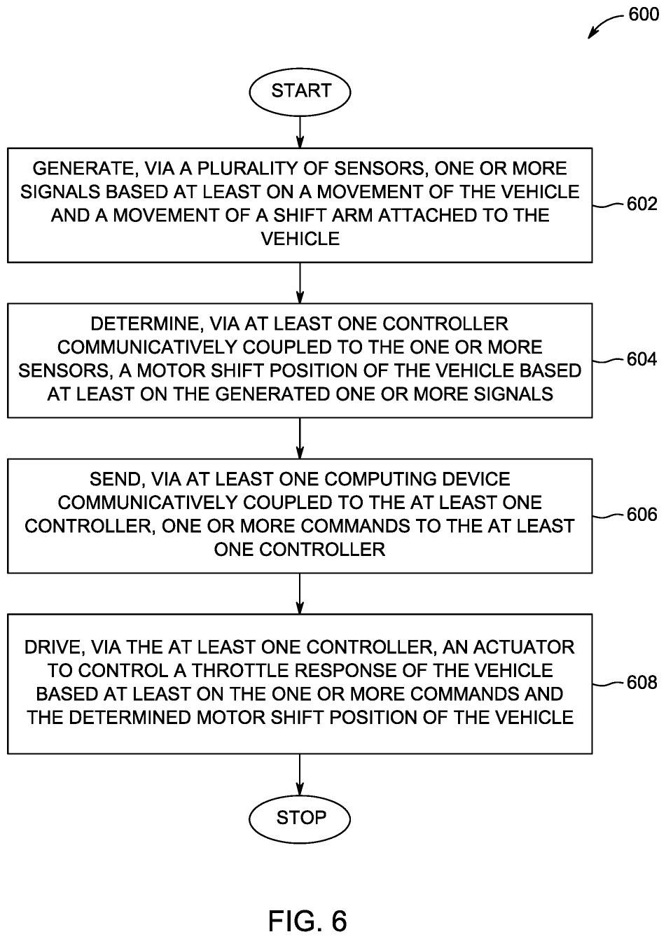

FIG. 6 is a flowchart illustrating a method 600 for the wireless throttle controller system 100, in accordance with at least one embodiment. FIG. 6 is described in conjunction with FIGS. 1A-5.

At first, generating, via a plurality of sensors 102, one or more signals based at least on a movement of the vehicle and a movement of a shift arm 204 attached to the vehicle, at step 602. In some embodiment, the plurality of sensors 102 may correspond to one or more inertial measurement unit (IMU) sensors. It may be noted that the at least one of the IMU sensors may be a reference sensor 108 and other one of the IMU sensors may be a shift position sensor 110. Further, the reference sensor 108 and the shift position sensor 110 may include an accelerometer, a gyroscope and a magnetometer. In one embodiment, the reference sensor 108 may be mounted over the vehicle. Further, the reference sensor 108 may sense the real time movement of the vehicle. Further, the shift position sensor 110 may be mounted to the shift arm 204 of a motor 302 of the vehicle. Further, the shift position sensor 110 may sense movement of the shift arm 204 of the motor 302.

Successively, determining, via the at least one controller 104 communicatively coupled to the plurality of sensors 102, a motor shift position of the vehicle based at least on the received one or more signals, at step 604. In some embodiment, the at least one controller 104, based on the real time movement of the vehicle and the movement of the shift arm 204, may determine the motor shift position of the vehicle. Further, the motor shift position of the vehicle may include neutral, forward and reverse. For example, the one or more signals from the plurality of sensors 102 are compared by the at least one controller 104 to determine that the motor shift position of the vehicle is in forward direction.

Successively, sending, via the at least one computing device 106, one or more input commands to the at least one controller, at step 606. In some embodiments, the at least one computing device 106 may include the smartphone 306, the PC 308, the purpose built Wi-Fi enabled remote 310 or the smart watch 312. For example, the user may send a command, using the smartphone 306, to change the throttle response of the vehicle to increase the speed of the vehicle.

Successively, driving, via the at least one controller 104, the actuator 124 to control a throttle response of the vehicle based at least on the one or more input commands and the determined motor shift position of the vehicle, at step 608. The actuator 124 may facilitate the throttle response of the vehicle based on at least one or more commands and the motor shift position of the vehicle determined by the at least one controller 104. In one embodiment, the actuator 124 may be a common radio control (RC) servo motor or a can stack linear actuator.

In one embodiment, the at least one controller 104 may drive the actuator 124 to control the throttle response of the vehicle upon determining the motor shift position of the vehicle in either forward or reverse position. It may be noted that the at least one controller 104 may terminate the activation of actuator 124 unless the motor shift position of the vehicle is shifted into forward or reverse position. For example, based on the input command sent by the user using the smartphone 306, the at least one controller 104 may drive the actuator 124 to control the throttle 126 response to increase the speed of the vehicle in forward direction.

It will be apparent to one skilled in the art that the above-mentioned embodiments of the present invention may be executed by the at least one controller 104 of the wireless throttle controller system 100 and the method 600 using the data from plurality of sensors 102, without departing from the scope of the disclosure.

The disclosed embodiments encompass numerous advantages that includes the ability to have the present invention installed under the cowling in a more simplified manner over other systems. The present invention does not require additional power sources, cutting wires, or making irreversible modifications to the boat, such as drilling through the transom wall or disassembly of the binnacle, for installation. The present invention instead only requires the power connection local under the cowling. Further, the present invention includes the ability to detect shift position without disassembly, cutting, or splicing of any motor wiring. The present invention instead detects shift position using sensors.

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the systems and methods described herein are illustrative only and are not limiting upon the scope of the claims.

What is claimed is:

1. A wireless throttle controller system comprising:
a plurality of sensors installed within a vehicle, configured to generate one or more signals based at least on a movement of the vehicle and a movement of a shift arm attached to the vehicle;
at least one controller communicatively coupled to the plurality of sensors, configured to determine a motor shift position of the vehicle based at least on the generated one or more signals; and
at least one computing device communicatively coupled to the at least one controller, and facilitates a user to send one or more commands to the at least one controller, and
wherein the at least one controller, based at least on the one or more commands and the determined motor shift position of the vehicle, controls a throttle response of the vehicle to precisely control speed of the vehicle.

2. The wireless throttle controller system of claim 1, wherein the at least one controller is installed underneath the cowling of motor of the vehicle.

3. The wireless throttle controller system of claim 2, wherein the controller is installed without additional power sources beyond the power connection under the cowling.

4. The wireless throttle controller system of claim 2, wherein the controller is installed without cutting or modifying the cowling.

5. The wireless throttle controller system of claim 1, wherein the plurality of sensors corresponds to one or more inertial measurement unit (IMU) sensors, and wherein at least one of the IMU sensors is a reference sensor and other one of the IMU sensors is a shift position sensor.

6. The wireless throttle controller system of claim 5, wherein the reference sensor and the shift position sensor correspond to an accelerometer, a gyroscope, and a magnetometer.

7. The wireless throttle controller system of claim 5, wherein the reference sensor is configured to be mounted within the vehicle to determine real time movement of the vehicle, and wherein the shift position sensor is coupled to a gear arrangement of the vehicle and to determine movement of the shift arm.

8. The wireless throttle controller system of claim 1, wherein the at least one controller is coupled to an actuator that facilitates controlling of throttle response of the vehicle based at least on the one or more commands and the determined motor shift position of the vehicle, and wherein the actuator is a common radio control (RC) servo motor or a stack linear actuator.

9. The wireless throttle controller system of claim 1, wherein the position of the at least one controller is re-oriented with recalibration of the wireless throttle controller system.

10. The wireless throttle controller system of claim 1, wherein the motor shift position of the vehicle includes neutral, forward, and reverse position.

11. The wireless throttle controller system of claim 10, wherein upon determining the motor shift position of the vehicle in either forward or reverse position, the at least one controller drives the actuator to control the throttle response of the vehicle.

12. The wireless throttle controller system of claim 1, wherein the at least one computing device includes a mobile phone, a remote controller, or a web browser.

13. The wireless throttle controller system of claim 1, wherein the at least one controller acts as a Wi-Fi-access point (AP) or a Wi-Fi station device to facilitate wireless communication with the at least one computing device operated by the user.

14. The wireless throttle controller system of claim 1, wherein the at least one controller implements a RESTful API or a web socket API to communicate with the user, wherein the at least one controller serves as a front end web application to the user to configure the at least one controller.

15. The wireless throttle controller system of claim 1, wherein the one or more commands comprises at least one of increasing the speed of the vehicle, decreasing the speed of the vehicle, setting the vehicle on cruise control, resetting the throttle, or setting throttle 126 position to idle.

16. A method comprising:
generating, via a plurality of sensors, one or more signals based at least on a movement of a vehicle and a movement of a shift arm attached to the vehicle;
determining, via at least one controller communicatively coupled to the one or more sensors, a motor shift position of the vehicle based at least on the generated one or more signals;
sending, via at least one computing device communicatively coupled to the at least one controller, one or more commands to the at least one controller; and
driving, via the at least one controller, an actuator to control a throttle response of the vehicle based at least on the one or more commands and the determined motor shift position of the vehicle,
wherein the at least one controller is installed underneath cowling of a motor of the vehicle.

17. The method of claim 16, wherein the controller is powered by local power under the cowling.

18. The method of claim 17, wherein the controller is installed without cutting the cowling or the vehicle.

19. The method of claim 16, wherein the plurality of sensors corresponds to one or more inertial measurement unit (IMU) sensors, and wherein at least one of the IMU sensors is a reference sensor and other one of the IMU sensors is a shift position sensor.

20. The method of claim 19, wherein the reference sensor and the shift position sensor correspond to an accelerometer, a gyroscope, and a magnetometer.

21. The method of claim 19, wherein the reference sensor is configured to be mounted within the vehicle to determine real time movement of the vehicle, and wherein the shift position sensor is coupled to a gear arrangement of the vehicle and to determine movement of the shift arm.

22. The method of claim 16, wherein the at least controller is coupled to an actuator that facilitates controlling of throttle response of the vehicle based at least on the one or more commands and the determined motor shift position of the vehicle, wherein the actuator is a common radio control (RC) servo motor or a stack linear actuator.

23. The method of claim 16, wherein the position of the at least one controller is re-oriented with recalibration of the wireless throttle controller system.

24. The method of claim 16, wherein the motor shift position of the vehicle includes neutral, forward, and reverse position.

25. The method of claim 24, further comprising, driving, via at least one controller, the actuator to control the throttle response of the vehicle upon determining the motor shift position of the vehicle in either forward or reverse position.
